(19) United States
(12) Patent Application Publication
(10) Pub. No.: US 2026/0364788 A1
(43) Pub. Date: Nov. 19, 2026

(54) GRASP STRATEGY FOR MANIPULATION USING A SIDE GRASP

(71) Applicant: Toyota Research Institute, Inc., Los Altos, CA (US)

(72) Inventor: Isabella Huang, San Jose, CA (US)

(73) Assignees: Toyota Research Institute, Inc., Los Altos, CA (US); Toyota Jidosha Kabushiki Kaisha, Toyota-shi (JP)

(21) Appl. No.: 19/438,030

(22) Filed: Dec. 31, 2025

Related U.S. Application Data
(60) Provisional application No. 63/805,403, filed on May 14, 2025.

(51) Int. Cl. B25J 9/16; B25J 11/00; B25J 15/08

(52) U.S. Cl. CPC B25J 9/1612; B25J 9/162; B25J 9/1676; B25J 9/1697; B25J 11/008; B25J 15/08

(57) ABSTRACT

Disclosed herein are apparatus, method, and computer-readable medium embodiments for providing grasp strategy for manipulation using a side grasp. An apparatus comprising a processing system that includes a processor and a memory coupled with the processor, the processing system is configured to receive image data capturing one or more objects from a plurality of imaging devices coupled to a mobile manipulator robot. The processing system identifies a target object comprising a bagged item from the one or more objects and extracts one or more geometric features of the target object from the image data. The processing system further selects a side grasp strategy to acquire the target object from a set of one or more grasp strategies based on the one or more geometric features of the target object. Finally, the processing system directs the mobile manipulator robot to execute the side grasp strategy.

### CROSS REFERENCE TO RELATED APPLICATION

This Non-Provisional Patent Application claims priority to Provisional Patent Application No. 63/805,403, which was filed on May 14, 2025, the entire contents of which are incorporated herein by reference.

### TECHNICAL FIELD

Aspects of the present disclosure relate to grasp strategy for manipulation using a side grasp.

### BACKGROUND

Robotic mobile manipulation is a highly active, multi-faceted area of research in which the ultimate objective is to enable autonomous robots to perform human-level tasks in diverse and complex environments. Despite vast amounts of robotics research having been conducted over several decades, autonomous robots still struggle to operate in the real world, outside of specifically designed or modified environments. However, such limitations in the field are not surprising since robotic mobile manipulation in human environments has proven to be an extremely challenging endeavor. To successfully navigate a real-world environment, autonomous robots must complete various tasks including, but not limited to, accurately perceiving their surroundings to estimate their location and detect obstacles, landmarks, or objects of interest, generating collision-free motion plans to and from objects or locations of interest while avoiding obstacles, and manipulating a wide variety of unseen objects. Each of the above tasks constitutes a difficult research problem on its own, and much of current robotics research focuses on individual challenges in the robotics pipeline. Although this approach has led to significant progress in developing individual aspects of the mobile manipulation problem (e.g., motion planning, scene segmentation, grasping, etc.), relatively little work has been done that combines these capabilities and evaluates them in real-world environments.

Studying system-level performance of autonomous robots in a real-world environment may help to advance the field of robotics by identifying and tackling fundamental problems that stand in the way of more widespread deployment of robots but are potentially overlooked by research efforts focused on individual tasks. For example, motion planning research continues to push for more optimal trajectories in minimal time, while often settling for 90 or 95 percent success rates. However, at a system level, the effect of a single percentage drop in success rates far outweighs even a significant drop in path optimality or computation time. Grasping and placing of a large diversity of novel items is one example of a fundamental problem in mobile manipulation that requires large-scale study to achieve the widespread deployment of autonomous robots. Since most real-world tasks require physically interacting with objects, and not just sensing or moving around, robust grasping is particularly important for the deployment of autonomous robots across industries, such as manufacturing (e.g., handling parts or assembling components), logistics (e.g., sorting materials, picking items, or packing boxes), or service (e.g., shopping or cleaning).

Grocery stores and warehouses are particularly good environments to study system-level performance of autonomous robots, including the grasping and placing of items, because they feature a host of unique, real-world challenges (e.g., item density, narrow navigable areas, and tight pick points) that are characteristic of settings designed for humans rather than for the ease of robot manipulation. Given that a single shopping run can contain a long list of items, an order fulfillment or shopping task requires an autonomous robot to be reliable and encourages a focus on overall execution speed. Such tasks are also beneficial because they allow for the collection of intuitive metrics (e.g., number of items that the robot correctly retrieved, number of items that the robot mistakenly grabbed, and time that the robot took to complete the task) to measure performance and drive further development of robotic manipulation. Furthermore, grocery stores and warehouses also contain a vast assortment of items, ranging from small and lightweight products to heavy goods and bagged items. The diversity of items necessitates not only the use of specialized tools, but also distinct grasping strategies tailored to characteristics of each item (e.g., geometric features, display fixture, item type). Although significant progress has been made over the past decade showing mobile manipulators grasping a diversity of items in lab settings, many grasping works abstract away different parts of the robot stack, leading to assumptions (e.g., perfect perception, known obstacle geometries, etc.) that do not hold in the real-world. In fact, few works have been able to make the jump to the real world or exhibited reliability close to what is necessary for real-world deployment

Accordingly, what is needed is an improved method and system for selecting and executing appropriate grasp strategies for different types of objects detected by an autonomous robot.

### SUMMARY

Certain aspects provide a computer-implemented method of receiving image data capturing one or more objects from a plurality of imaging devices coupled to a mobile manipulator robot; identifying a target object to be grasped by the mobile manipulator robot from the one or more objects in the image data, wherein the target object comprises a bagged item; extracting one or more geometric features of the target object from the image data; selecting a side grasp strategy to acquire the target object from a set of one or more grasp strategies based on the one or more geometric features of the target object; and directing the mobile manipulator robot to execute the side grasp strategy.

Certain aspects provide an apparatus comprising a processing system that includes one or more processors and one or more memories coupled with the one or more processors, the processing system configured to cause the processing system to: receive image data capturing one or more objects from a plurality of imaging devices coupled to a mobile manipulator robot; identify a target object to be grasped by the mobile manipulator robot from the one or more objects in the image data, wherein the target object comprises a bagged item; extract one or more geometric features of the target object from the image data; select a side grasp strategy to acquire the target object from a set of one or more grasp strategies based on the one or more geometric features of the target object; and direct the mobile manipulator robot to execute the side grasp strategy.

Certain aspects provide an mobile manipulator robot, comprising: a chassis coupled to a body; one or more robotic arms coupled to and extended from the body, wherein at least one robotic arm of the one or more robotic arms is coupled to antipodal gripper; an imaging device coupled to the body and configured to capture one or more objects in an environment; one or more transportation components coupled to the chassis, the one or more transportation components configured to move in a plurality of directions; a processing device in communication with the one or more robotic arms, the imaging device, and the one or more transportation components; a non-transitory, computer-readable storage medium in communication with the processing device, wherein the non-transitory, computer-readable storage medium comprises programming instructions that, when executed, cause the processing device to perform operations, the operations comprising: receiving image data capturing one or more objects from a plurality of imaging devices coupled to a mobile manipulator robot; identifying a target object to be grasped by the mobile manipulator robot from the one or more objects in the image data, wherein the target object comprises a bagged item; extracting one or more geometric features of the target object from the image data; selecting a side grasp strategy to acquire the target object from a set of one or more grasp strategies based on the one or more geometric features of the target object; and directing the mobile manipulator robot to execute the side grasp strategy.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 illustrates an example computing environment, in accordance with aspects of the disclosure.

FIG. 2 illustrates an example embodiment of a mobile manipulator robot, in accordance with aspects of the disclosure.

FIG. 3 illustrates an example software stack for mobile manipulation, in accordance with aspects of the disclosure.

FIG. 4 illustrates an example pipeline of grasp planner module, in accordance with aspects of the disclosure.

FIG. 5 illustrates an example method for grasp strategy classification and tool selection, in accordance with aspects of the disclosure.

FIG. 6 illustrates an example method to select and execute a side grasp strategy for manipulation of a bagged item, in accordance with aspects of the disclosure.

FIG. 7 illustrates an example method to identify a movable object from a subset of objects near a target object, in accordance with aspects of the disclosure.

FIG. 8 illustrates an example processing system for performing the example method to select and execute a side grasp strategy for manipulation of a bagged item, in accordance with aspects of the disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

The present disclosure, in one form, is related to apparatuses, mobile manipulator robots, and methods for selecting and executing a grasp strategy for manipulation using a side grasp. For example, embodiments of an apparatus for selecting and executing a grasp strategy for manipulation using a side grasp described herein comprise a processing system that includes one or more processors and one or more memories coupled with the one or more processors, the processing system configured to: receive image data capturing one or more objects from a plurality of imaging devices coupled to a mobile manipulator robot, identify a target object to be grasped by the mobile manipulator robot from the one or more objects in the image data, wherein the target object comprises a bagged item, extract one or more geometric features of the target object from the image data, select a side grasp strategy to acquire the target object from a set of one or more grasp strategies based on the one or more geometric features of the target object, and direct the mobile manipulator robot to execute the side grasp strategy.

An advantage of the present disclosure is that the various embodiments described herein improve upon existing robotic mobile manipulation systems by offering robust grasp strategies for handling different types of objects in various environmental contexts. This enhancement enables mobile manipulator robots to operate safely, reliably, and autonomously in uncertain, dynamic environments, making them suitable for real-world applications rather than just controlled laboratory settings.

### Example Environment for Grasp Strategy for Manipulation Using a Side Grasp

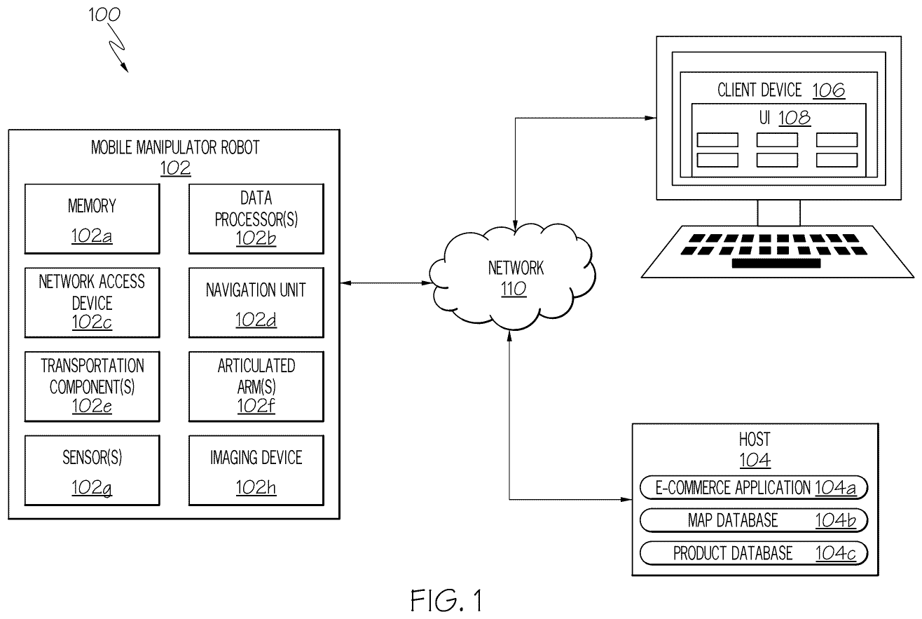

FIG. 1 depicts an example computing environment 100 for selecting and executing a grasp strategy for manipulation using a side grasp. As shown in FIG. 1, computing environment 100 may comprise a mobile manipulator robot 102, a host 104, client device 106, and a user interface (UI) 108 interconnected through a network 110. Network 110 may be, for example, a direct link, a local area network (LAN), a wide area network (WAN), such as the Internet, another type of network, or a combination of one or more of these networks.

Mobile manipulator robot 102 may be an autonomous robot that comprises a memory 102(a), one or more data processors 102(b), a network access device 102(c), a navigation unit 102(d), one or more transportation components 102(e), one or more articulated arms 102(f), one or more sensors 102(g), and an imaging device 102(h).

The memory 102(a) may store instructions to execute on the one or more data processors 102(b) and may include one or more of a random-access memory (RAM) or other volatile or non-volatile memory. The memory 102(a) may be a non-transitory memory or a data storage device, such as a hard disk drive, a solid-state disk drive, a hybrid disk drive, or other appropriate data storage, and may further store machine-readable instructions, which may be loaded and executed by the one or more data processors 102(b) that may be coupled to the memory 102(a).

The one or more data processors 102(b) may further be coupled to at least one of the network access device 102(c), the navigation unit 102(d), the one or more transportation components 102(e), the one or more articulated arms 102(f), the one or more sensors 102(g), and the imaging device 102(h). The network access device 102(c) may be configured to allow the mobile manipulator robot 102 to connect to the host 104 in order to receive instructions to obtain one or more objects from various locations in an environment (e.g., a warehouse, a grocery store, or department store), a previously generated map of the environment indicating locations of objects stored therein, or product data relating to objects that the mobile manipulator robot 102 may encounter in the environment. Navigation unit 102(d) may be configured to perform various navigation functions. For example, the navigation unit 102(d) may receive a motion plan defining a collision-free route to one or more locations in an environment and provide navigation instructions guiding the mobile manipulator robot 102 to the one or more locations in an environment. In some aspects, the one or more locations may include the positions of one or more objects to be grasped by the mobile manipulator robot 102 in the environment.

The one or more transportation components 102(e) may comprise a motor coupled to one or more wheels or one or more treads that are configured to move a chassis housing other components of the mobile manipulator robot 102 in multiple directions based on navigation instructions provided by the navigation unit 102(d). In some aspects, the one or more transportation components 102(e) may also include one or more battery packs, wherein each battery pack may comprise a plurality of lithium-ion (Li-Ion) batteries. Additionally, in some aspects, each battery pack may plug directly into a custom power board stack in the center of the chassis which monitors and controls a power system for the mobile manipulator robot 102.

The one or more articulated arms 102(f) may comprise a plurality of linkages and a plurality of joints that together imitate the function and range of motion of a human arm. In some aspects, the one or more articulated arms 102(f) may be coupled to, and extended from, a body structure attached to the chassis. In some aspects, each of the one or more articulated arms 102(f) may also be coupled to a grasping tool (e.g., a suction gripper or antipodal gripper) that are configured to grasp or manipulate an object in the environment. Furthermore, the mobile manipulator robot 102 may be equipped with one or more sensors 102(g) that are configured to provide feedback or state data for certain components of the mobile manipulator robot 102. In some aspects, the one or more sensors 102(g) may include sensors that are coupled to each of the one or more articulated arms. For example, the one or more sensors 102(g) may comprise a plurality of rotation angle sensors that measure the rotation angles of the plurality of joints in each of the one or more articulated arms 102(f). In some aspects, the one or more sensors 102(g) may also include sensors that are coupled to a grasping tool. For example, the one or more sensors 102(g) may comprise at least one of a proximity sensor that measures how close the grasping tool is to an object to be grasped, a force sensor that measures the amount of force or pressure applied to an object to be grasped by the grasping tool, or a position sensor that measures a position of a grasping tool and/or identifies a deviation of the grasping tool from the intended path.

Imaging device 102(h) may comprise one or more cameras that are configured to record image data capturing one or more objects at a particular location in the environment. In some aspects, the image data may include a plurality of images or a video recording comprising a sequence of frames. Furthermore, in some aspects, the image data may be used to determine a strategy (e.g., a sequence of movements) to approach, grasp, and/or manipulate an object in the environment.

Host 104 in computing environment 100 may be geographically co-located servers on the same rack or on different racks in any arbitrary location in a data center. Host 104 may be constructed on a server grade hardware platform and include components of a computing device such as, one or more processors (e.g., central processing units (CPUs)), one or more memories (e.g., random access memory (RAM)), one or more network interfaces (e.g., physical network interfaces (PNICs)), data storage, or other components. Furthermore, Host 104 may support or host a plurality of microservices. Generally, a microservice is a loosely coupled and independently deployable service or software that, alone or in combination with one or more other microservices 104, may make up an application. Microservices may enable segmented, granular level functionalities within a larger system infrastructure. As shown in FIG. 1, the plurality of microservices supported by Host 104 may include, but are not limited to, an e-commerce application 104(a), an environment map database 104(b), and a product database 104(c). E-commerce application 104(a) may provide an online marketplace where users may search for and select one or more objects for purchase. Furthermore, e-commerce application 104(a) may provide a list of one or more objects to be grasped by the mobile manipulator robot 102 based on the objects identified in a completed transaction. Map database 104(b) may comprise at least one map of an environment corresponding to the e-commerce application 104(a), wherein the at least one map specifies a specific or relative location in the environment for each object available for sale in e-commerce application 104(a). Product database 104(c) may comprise a plurality of data elements relating to characteristics of object available for sale in commerce application 104(a). In some aspects, the plurality of data elements may include, but is not limited to, an identifier (e.g., commercial mark or tradename), a stock-keeping unit (SKU) code number or uniform product code (UPC) number, a category designation, one or more physical dimensions (e.g., height, width, weight, volume, etc.), packaging type, packaging materials, or sales price.

Client device 106 may be a desktop computer, laptop computer, tablet computer, smartphone, cellular telephone, personal digital assistant, or any other type of computing device. UI 108 may comprise a graphical user interface (GUI) of a software application operating on client device 106. Software applications may include web browser applications that enable users to access content on remote services or interact with microservices operating on the remote servers, such as an e-commerce application 108(a) or a product database 108(c) on host 104, using network 110. Some examples of web browser applications may include Google Chrome™, Mozilla Firefox™, Microsoft Edge™, Opera™, and Apple Safari™.

UI 108 may comprise one or more GUI elements including, but are not limited to, an input element, a submission element, and an output element. The input element may be configured to receive distinct types of user-provided data including, but not limited to, one or more text strings, one or more audio files, one or more image files, or a sequence of one or more graphical user interface clicks. The input element may be configured to receive the user-provided data from an input device such as a keyboard, a camera, a microphone, a mouse, or a voice-to-text program. In some aspects, the user-provided data may comprise a list of one or more objects that a user seeks to purchase in a transaction with the e-commerce application 104(a). Alternatively, the user-provided data may specify a search query to the e-commerce application 104(a) or the product database 104(c) for an object that is of interest to a user. The submission element may be a button (or other type of GUI element) configured to cause the UI 108 to transmit the user-provided data to host 104. The UI 108 may transmit the user-provided data to the microservice instantly upon, or shortly after, receiving an indication of user interaction (e.g., click, toggle, etc.) with the submission element. The output element may be configured to receive and display a response from the microservice. A response may be a relevant, existing content item retrieved from a database by the microservice or a new content item generated by the microservice based on user-provided data, such as one or more text strings specifying an answer to a question previously posed by the user.

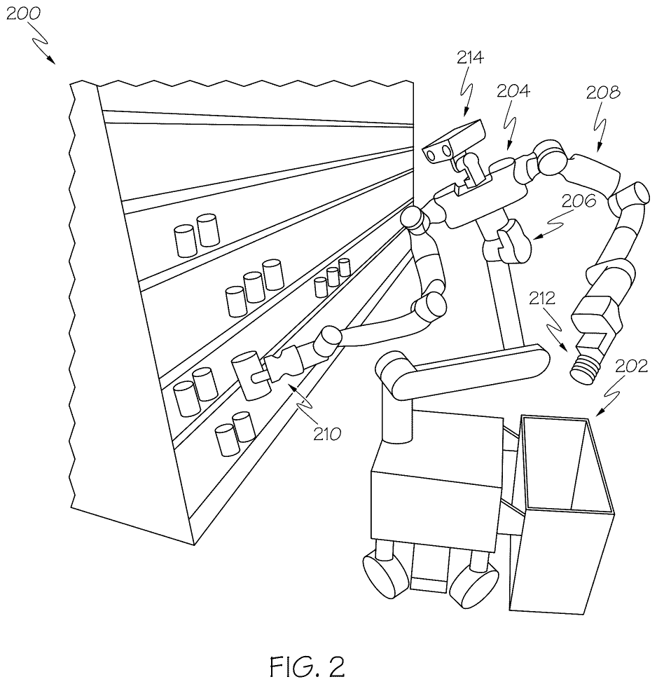

FIG. 2 depicts an example embodiment of mobile manipulator robot 102 previously described in FIG. 1 and further illustrates key hardware components, such as the one or more transportation components 102(e), the one or more articulated arms 102(f), and the imaging device 102(h). The one or more transportation components 102(e) may comprise a pseudo-holonomic four-wheeled chassis 202. As shown in FIG. 2, the mobile manipulator robot 200 may further comprise a five-degree-of-freedom (5-DoF) torso 204 coupled to, and extending from, the pseudo-holonomic four-wheeled chassis 202 and a 2-DoF pan-tilt platform 206 extending from the 5-DoF torso 204. The one or more articulated arms 102(f) may comprise two 7-DoF arms 208. In some aspects, the 5-DoF torso 204, 2-DoF pan-tilt platform 206, and the two 7-DoF arms 208 may each comprise a plurality of joints powered by rotary actuators that are tightly integrated and are configured to have very high specific torques and torque densities. Each rotary actuator may also have a torque sensor, an output position encoder, and an integrated custom motor controller capable of communicating with other motor controllers or the one or more data processors 102(b) via a controller area network (CAN) and EtherCAT.

The two 7-DoF arms 208 may each include a tool interface configured to allow different grasping tools to be manually installed and removed. For example, a left robotic arm (or first robotic arm) may be equipped with a suction gripper 212, and a right robotic arm (or second robotic arm) may be equipped with an antipodal gripper 210 (e.g., Robotiq HandE™ gripper). In some aspects, the antipodal gripper 210 may comprise a plurality of fingers that are configured to partially surround an object, grasp the object, release the object, or the like. As shown in FIG. 2, antipodal gripper 210 may include two opposing fingers such that at least one finger moves away from the other finger to open antipodal gripper 210 and such that at least one finger moves towards the other finger to close antipodal gripper 210. Alternatively, antipodal gripper 210 may include more than two fingers (e.g., 3, 4, or 5 fingers) that together may function like fingers on a human hand. In some aspects, the suction gripper 212 may comprise two vacuum generators: a low flow rate generator (e.g., Robotiq EPick™) with an integrated diaphragm pump capable of producing high vacuum levels and a high-speed axial pump configured to produce larger flow rates, albeit at lower vacuum levels. The high-speed axial pump may be used for making initial contact with objects and to hold onto bags that are inherently challenging for suction grasps. If the internal pressure of suction gripper 212 indicates a sufficient seal with the object following initial contact, the suction gripper 212 may switch to the low flow rate generator with the integrated diaphragm pump to take advantage of its much stronger vacuum. In some aspects, each of the 7-DoF arms 208 may be further equipped with a six-axis force/torque sensor mounted between a wrist linkage and the tool interface.

Finally, the imaging device 102(h) may comprise one or more stereo camera pairs 214. In some aspects, the one or more stereo camera pairs 214 may include a pair of color cameras with wide-angle lenses (e.g., Basler acA2500-60uc™) mounted on the 2-DoF pan-tilt platform 206 and another front-facing pair mounted to the four-wheeled chassis 202.

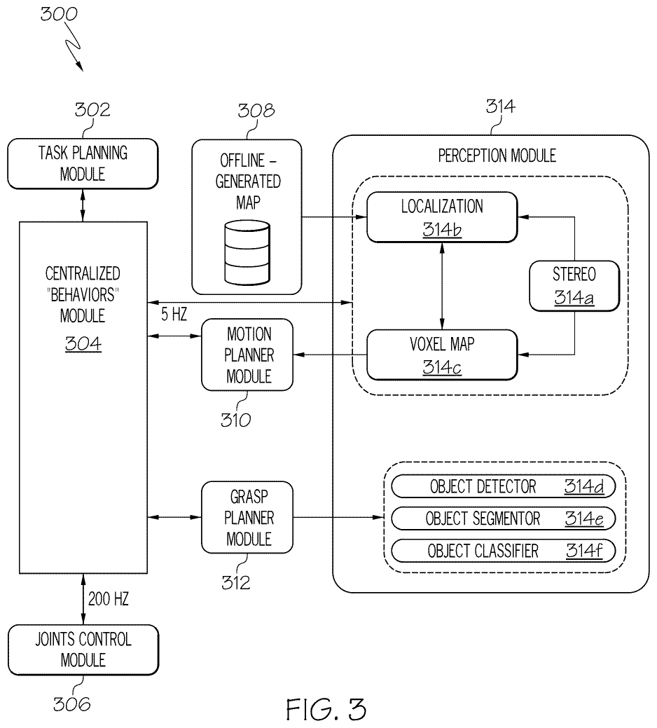

FIG. 3 illustrates an example software stack 300 for mobile manipulation. The software stack 300 may comprise a task planning module 302, a centralized behaviors module 304, a joints control module 306, an offline-generated map 308, a motion planner module 310, a grasp planner module 312, and a perception module 314. In some aspects, one or more modules of the software stack may comprise processing logic that can include hardware (e.g., circuitry, dedicated logic, programming logic, microcode, etc.), software (e.g., instructions executing on a processing device), or a combination thereof.

Task planning module 302 may be a finite state machine that guides the high-level actions of the mobile manipulator robot 200. In some aspects, the task planning module 302 may be configured to trigger transitions between a plurality of states (e.g., tasks) including, but not limited to, “Idle,” “Navigate to Item,” “Detect Item,” “Get Item,” and “Place Item,” based on input(s) obtained from one or more components of the mobile manipulator robot 200 and/or software stack 300. For example, upon receiving a customer shopping list comprising a plurality of objects from host 104, the task planning module 302 may trigger a transition from an “Idle” state to a “Navigate to Item” state and transmit a request to the centralized behaviors module 304 to instruct the mobile manipulator robot 200 to navigate to an item on the customer shopping list. Upon receiving an indication from the navigation unit 102(d) and/or localization component 314(b), via the centralized behaviors module 304, that the mobile manipulator robot 200 is near the item, the task planning module 302 may trigger a transition from the “Navigate to Item” state to a “Detect Item” state and transmit a request to the centralized behaviors module 304 to execute object detection 314(d), object segmentation 314(e), and object classification 314(f) components of perception module 314 to find the item. Upon receiving an indication from the object classifier 314(f), via the centralized behaviors module 304, that the mobile manipulator robot 200 has successfully detected the item, the task planning module 302 may trigger a transition from the “Detect Item” state to a “Get Item” state and transmit a request to the centralized behaviors module 304 to trigger the grasp planner module 312 to determine and implement a grasp strategy for the item. Afterwards, the task planner module 302 may further trigger a transition from the “Get Item” state to a “Place Item” state and transmit a request to the centralized behaviors module 304 to implement an extraction strategy for placing the first item in a basket attached to chassis 202. However, if the task planner module 302 receives an indication that the mobile manipulator robot 200 failed to move a location near the item, failed to detect the item, or failed to determine and/or successfully implement a grasp strategy for the item, the task planning module 302 may maintain or revert to the “Navigate to Item” state and send a request to the centralized behaviors module 304 to instruct the mobile manipulator robot 200 to navigate to the next item on the customer shopping list.

Centralized behavior module 304 may be configured to exercise exclusive control over the one or more transportation components 102(e) as well as joints in the 5-DoF torso 204, 2-DoF pan-tilt platform 206, two 7-DoF arms 208, and/or the plurality of fingers in the antipodal gripper 210. Such an arrangement may provide the added technological benefit of simplifying the system architecture and reducing the potential for conflicts between the various modules of the software stack 300. In some aspects, once the task planning module 302 decides which action to take, the centralized behavior module 304 may be configured to query perception module 314 at 5 Hz and/or other planning modules (e.g., motion planner module 310 or grasp planner module 312) to aggregate all necessary information and send low-level commands to one or more mechanical components of the mobile manipulator robot 200, such as the one or more transportation components 102(e) or the actuators (e.g., servomotors) driving the joints of the 5-DoF torso 204, 2-DoF pan-tilt platform 206, two 7-DoF arms 208, and/or the plurality of fingers in the antipodal gripper 210, via the joint control module 306.

In addition to receiving low-level commands from centralized behavior module 304 and communicating those commands to actuators driving various joints of the mobile manipulator robot 200 via a CAN or EtherCAT network, the joints control module 306 may be configured to perform feedback control using measurements from the one or more sensors 102(g). For example, in some aspects, the joints control module 306 may ensure that the joints in the 5-DoF torso 204 and each of the 7-DoF arms 208 have target rotation angles based on the rotation angles from the corresponding rotation angle sensors. In some aspects, the joints control module 306 may be configured to receive data from and transmit data to centralized behavior module 304 at 200 Hz.

Map 308 may be a dense three-dimensional (3D) reconstruction of the environment that also comprises locations of various objects stored therein. In some aspects, map 308 may be generated offline, prior to the deployment of the mobile manipulator robot 200, by a mapping pipeline using a time-ordered stream of stereo images acquired by multiple stereo cameras attached to a mapping rig moving through the environment. A learned stereo network may be applied to each image pair to compute per-pixel depth. The learned stereo network may further detect keypoints (e.g., places with high contrast, corners, edges, blobs, or other unique patterns that stand out from their surroundings) in each image and store a RootSIFT descriptor for every keypoint that has a valid depth.

In some aspects, the mapping pipeline may generate map 308 based on the detected keypoints and the RootSIFT descriptors using the following four steps: (1) Visual Odometry; (2) Loop Detection and Closure; (3) Bundle Adjustment; and (4) Mapping Items. Visual odometry may entail the mapping pipeline estimating camera pose deltas between each pair of subsequent left images (Lₖ₋₁, Lₖ). The mapping pipeline may match RootSIFT descriptors in image Lₖ₋₁ to their nearest neighbors in image Lₖ (and vice versa). Keeping only mutual nearest neighbors as valid correspondences, the mapping pipeline may calculate the pose of image Lₖ relative to image Lₖ₋₁ by running a Perspective-n-Point (PnP) solver within a RANSAC (Random Sample Consensus) loop. Since visual odometry leads to pose drift, the mapping pipeline may perform loop detection to correct for accumulated pose error. A NetVLAD-based network (e.g., a convolutional neural network with a NetVLAD layer) may be trained to output a global image descriptor Gₖ for each image Lₖ. To detect a loop closure, the mapping pipeline may identify the five nearest neighbors to Gₖ and compute pose deltas between the corresponding images and Lₖ by again running the PnP solver within the RANSAC loop. The mapping pipeline may accept the pose delta with the highest number of inliers (if that number exceeds 200) and correct for the pose drift using a deformation modeling technique. Afterwards, the mapping pipeline may further obtain a set of refined 3D point coordinates and camera poses by passing the 2D locations of the inlier keypoints, initial estimates of the 3D coordinates of the physical points we want to reconstruct (computed by averaging the 3D coordinates of corresponding keypoints), and the camera poses computed by visual odometry and loop closures to a bundle adjustment algorithm. Bundle adjustment may comprise an optimization algorithm to jointly refine camera parameters and 3D point positions so that they are maximally consistent with the observed image data. The resulting set of refined 3D point coordinates and camera poses produce a dense and clean 3D geometric reconstruction of the environment for collision-free navigation. Finally, the mapping pipeline may further enrich map 308 with locations of the objects stored in the environment. In some aspects, the mapping pipeline may additionally trigger execution of object detection 314(d), object segmentation 314(e), and object classification 314(f) components of the perception module 314 on each image of the time-ordered stream of stereo images to identify every unique object and its predicted universal product code (UPC). Furthermore, since all camera poses are registered within a coherent map coordinate system, the mapping pipeline may obtain the location of each unique object by transforming the point cloud associated with the object according to the corresponding camera pose and computing a centroid.

Motion planner module 310 may be configured to generate a motion plan (e.g., a collision-free route) for navigating to one or more items in an environment upon receiving an instruction to do so from the centralized behaviors module 304. In some aspects, centralized behaviors module 304 may instruct the motion planner module 310 to generate a motion plan in response to receiving a request to instruct the mobile manipulator robot 200 to navigate to an item on the customer shopping list from the task planner module 302. In some aspects, motion planner module 310 may generate a motion plan using a dynamic roadmap and a voxel map. A dynamic roadmap may be a graph of feasible motions in an environment comprising a plurality of nodes (e.g., destinations, decision points, or points of interest) and a plurality of edges (e.g., aisles, corridors, or other navigable paths between nodes). A voxel map may be a 3D grid-based map where each cell, or voxel, represents a small volume of space and contains data such as color, occupancy (e.g., free, occupied, or unknown), or semantic labels (e.g., object, wall, floor, or person). For example, when a motion plan is requested, motion planner module 310 may use the voxel map generated by voxel map component 314(c) of the perception module 314 to identify and prune out all nodes in the dynamic roadmap that collide with a collision body in the voxel map. This process can be extremely fast since most collision-checks are performed offline and prior to deployment of the mobile manipulator robot 200 based on the robot model (e.g., robot footprint) and stored for efficient online queries. For collision-checks that cannot be done offline (e.g., if the robot model changes because it grabbed an item), motion planner module 310 may leverage graphics processing unit(s) to accelerate collision-checking and pruning out any nodes in collision with any newly added collision bodies. Afterwards, motion planner module 310 may assume the remaining nodes in the dynamic roadmap to be collision-free and identifies the shortest collision-free path required to visit all items on the customer shopping list. In some aspects, motion planner module 310 may, using the Christofides algorithm, organize the items on the customer shopping list as a sequence of navigation targets that minimizes the path length required to visit all requested items. Finally, motion planner module 310 may also be configured to determine the target pose (e.g., pre-grasp pose) of at least one 7-DoF arm 208. In some aspects, motion planner module 310 may compute angles for a plurality of joints to achieve the target pose of the 7-DoF arm 208 using optimization-based inverse kinematics.

Grasp planner module 312 may be configured to generate a plan for grasping and extracting an item from its location in an environment. In some aspects, grasp planner module 312 may select a grasping strategy for different types of items in different environmental contexts using a learned mapping between a perceived item and a discrete, comprehensive set of grasp strategies. In some aspects, the set of grasp strategies may comprise a 2D antipodal-based grasp, an approach-based grasp, a handle-item grasp, a pinch grasp, a side grasp, and a suction grasp. The set of grasp strategies are summarized below.

2D Antipodal-based grasp: In some aspects, grasp planner module 312 may apply a 2D antipodal-based grasp strategy (also known as 2D gripper grasp strategy) to shelved items. To simplify the problem of grasping shelved items, the grasp planner module 312 may reduce it to a 2D problem by constraining the grasp approach pose to be perpendicular to the item's front face. The grasp planner module 312 may project the item's segmented point cloud onto this plane and compute a 2D concave hull around the item's shape. The grasp planner module 312 may further randomly sample antipodal grasp points along the hull's boundary, where pairs of antipodal points that fall within the gripper's stroke width are considered valid candidates. The grasp planner module 312 may then select the candidate that is farthest from potential collisions as the optimal grasp.

Approach-based grasp: In some aspects, grasp planner module 312 may apply an approach-based grasp strategy to items that are not shelved and found in bins or piles, such as produce. In such cases, the grasping problem shifts from 2D to 3D, requiring grasp sampling in three dimensions. The grasp planner module 312 may extrapolate a 3D ellipsoidal hull of the item using a partially observed point cloud. While antipodal grasps are typically more stable due to near-perpendicular contact normals, they are highly prone to collisions when dealing with piled items. As a result, very few antipodal grasps are viable in produce-grasping scenarios.

Handled-item grasp: In some aspects, grasp planner module 312 may apply a handle-item grasp strategy for heavy objects with handles. For heavy objects with handles, grasping at the handle provides the most stable hold by leveraging finger support (e.g., support from one or more of the plurality of fingers of the antipodal gripper 210 in FIG. 2). These objects are often shelved with a prominently visible handle opening, which is then captured in the 2D concave hull. However, if the handle curves outward, the opening may be obscured. To account for this, the grasp planner module 312 may utilize geometric grasp sampling about the 2D concave hull and handle keypoint detection with. If a hole cannot be detected with geometric grasp sampling about the 2D concave hull of the item, the grasp planner module 312 may identify and use a keypoint to determine the grasp location. Since handle-item grasps require that one finger of the antipodal gripper 210 to be inside the opening and the other outside the handle for stability, grasp planner module 312 may impose a strict tool pose constraint for items that exceed three kilograms to prevent slippage during grasping and/or extraction.

Pinch grasp: In some aspects, grasp planner module 312 may apply a pinch grasp to items that are too small for suction grasp and too wide for the 2D antipodal-based grasp, such as short cans. A pinch grasp may comprise pinching the top front edge of the item between a gripper's jaws (or fingers of the antipodal gripper 210 in FIG. 2).

Side grasp: In some aspects, grasp planner module 312 may apply a side grasp to bagged items. Bagged items are too wide for the 2D antipodal-based grasp, and they are not compatible with a suction gripper (e.g., suction gripper 212 in FIG. 2) since bag materials are often porous, too soft to form a good seal, or too heavy, causing shear forces that detach the item from the suction cup immediately. In these cases, grasp planner module 312 may apply a side grasp, wherein fingers of the antipodal gripper 210 grasp the bagged item from the side and intermediate waypoints are used to push aside any neighboring items that block access to the bagged item. The grasp planner module 312 may also determine which side (e.g., left or right) of the bagged item to grasp in order to further minimize collisions with nearby items or fixtures. Furthermore, although the ideal approach angle is perpendicular to the bagged item face, the approach angle may be adjusted during runtime to avoid interference with surrounding obstacles.

Suction grasp: In some aspects, grasp planner module 312 may apply a suction grasp to items that are not bagged items, are not produce, and/or not items with handles. To determine optimal suction points, the grasp planner module 312 may subsample the item's 3D point cloud and project it into a 2D concave hull. The projection plane may depend on the item's environmental context (e.g., vertical for shelved or hanging items and parallel to the camera for loose produce). The concave hull may define signed distances from its edge, which the grasp planner module 312 may use to rank suction locations. For shelved items, the ranking favors greater signed distances while biasing toward the top of the item to minimize moment loads under angular deflection at the suction interface, a crucial factor for heavier items. For hanging objects or piled produce, the ranking is based solely on signed distance. Grasp planner module 312 may evaluate suction points consecutively, using a flatness metric for grasp quality. Grasp planner module 312 may further select the first collision-free suction point candidate with sufficient flatness as compared to prior suction point candidates.

Perception module 314 may be configured to keep mobile manipulator robot 200 localized and aware of obstacles by generating a stereo point cloud and a voxel map for spatial awareness. Perception module 314 may also be configured to query motion planning module 310 whenever the mobile manipulator robot 200 needs to plan a motion or query grasp planning module 312 whenever the mobile manipulator robot 200 needs to grasp an item. In some aspects, perception module 314 may be configured to operate at 5 Hz and comprise one or more components including, but not limited to, a stereo component 314(a), localization component 314(b), voxel map component 314(c), object detector 314(d), object segmenter 314(e), and object classifier 314(f). In some aspects, stereo component 314(a), localization component 314(b), and voxel map component 314(c) may assist the mobile manipulator robot 200 with perceiving and navigating its broader environment while the object detector 314(d), object segmenter 314(e), and object classifier 314(f) may assist the mobile manipulator robot 200 with perceiving and interacting with one or more target objects.

Stereo component 314(a) may be configured to produce one or more dense and accurate depth images (e.g., Red, Green, Blue, Depth (RGB-D) images) from camera pairs mounted on the head and chassis of the mobile manipulator robot 200, such as the one or more stereo camera pairs 214 that are depicted and described in FIG. 2. In some aspects, the stereo component 314(a) may generate accurate depth images by applying a learned stereo network to each stereo image pair obtained from the one or more stereo camera pairs 214 to compute per-pixel depth.

Localization component 314(b) may be configured to localize the mobile manipulator robot 200 within a grocery store or warehouse by estimating its pose (e.g., position and orientation) relative to map 308. To compute the pose of mobile manipulator robot 200, localization component 314(b) may obtain one or more RGB-D images that capture a scene at its current location from stereo component 314(a) and produce a 3D point cloud from each of the one or more RGB-D images. In some aspects, any known or yet to be known technique for generating 3D point clouds from one or more RGB-D images by one of ordinary skill in the art can be used in the embodiments disclosed in this document. In cases where multiple 3D point clouds represent a single scene and are generated using RGB-D images from multiple sources, such as the one or more stereo camera pairs 214 that are depicted and described in FIG. 2, the 3D point clouds may not align perfectly with each other by default due to imperfect kinematic calibration or disturbances caused by accidental collisions. However, point cloud alignment is crucial when a grasp of an object depends on perception from multiple sources. Thus, in some aspects, the localization component 314(b) may additionally execute an Iterative Closest Point (ICP) algorithm to alleviate misalignment between the 3D point clouds. Once the localization component 314(b) has acquired a 3D point cloud of the scene at the current location of mobile manipulator robot 200, localization component 314(b) may then compute the pose of the point cloud relative to map 308 by running a PnP solver within a RANSAC loop. In some aspects, localization component 314(b) may estimate the pose of mobile manipulator robot 200 at the start of a shopping task or when task planning module 302 triggers a transition from an “Idle” state to a “Navigate to Item” state. In some aspects, localization component 314(b) may additionally estimate the pose of the mobile manipulator robot 200 each time it successfully navigates to an item on an assigned customer shopping list.

Voxel map component 314(c) may be configured to generate a voxel map using RGB-D images from stereo component 314(a). As previously noted, a voxel map may be a 3D grid-based map where each cell, or voxel, represents a small volume of space and contains data such as occupancy (e.g., whether the space is free, occupied, or unknown). In some aspects, any known or yet to be known technique for generating a voxel map from RGB-D images by one of ordinary skill in the art can be used in the embodiments disclosed in this document. For example, voxel maps may be generated from RGB images by converting per-pixel depth information into 3D space and integrating the data over time into a volumetric grid.

Object detector 314(d) may be configured to detect one or more objects in an input image (e.g., an RGB-D image from stereo component 314(a)), generate a two-dimensional (2D) bounding box around each of the one or more detected objects, and output an image crop (or cropped image) of an object in each of the one or more 2D bounding boxes. In some aspects, object detector 314(d) may be implemented using any known technique or yet to be known technique for detecting one or more objects in an image. For example, object detector 314(d) may comprise a convolutional neural network (CNN) implementing a You Only Look Once (“YOLO”) object detection algorithm. Alternatively, the object detector 314(d) may comprise a transformer encoder-decoder implementing a Detection Transformer (“DETR”) object detection algorithm. Furthermore, in some aspects, object detector 314(d) may be trained using image data sets comprising real data, synthetic data, or a combination of both real and synthetic data.

Object segmenter 314(e) may be configured to produce a segmentation mask of an object in each of the one or more image crops output by object detector 314(d). A segmentation mask may be an image output derived from an input image crop that precisely outlines the shape of an object in the input image crop. Typically, a segmentation mask may have the same height and width dimensions of the input image crop, and each pixel in the segmentation mask is assigned a value that indicates which object or region a corresponding pixel in the input image crop belongs to. For example, a segmentation mask generated by object segmenter 314(e) may be a binary mask in which pixels are marked 1 when corresponding pixels in the input image crop are determined to belong to an object and the remaining pixels are marked 0. Additionally, object segmenter 314(e) may be configured to generate a 3D point cloud of an object in an image crop obtained from the object detector 314(d). For example, object segmenter 314(e) may overlay a segmentation mask with the RGB-D image from stereo component 314(a) to filter out pixels not belonging to the object in the input image crop from which the segmentation mask is derived. The object segmenter 314(e) may further generate a 3D point cloud of the object by back-projecting each pixel of the remaining pixels of the RGB-D image into a 3D point. In some aspects, object segmenter 314(e) may comprise a CNN (e.g., U-Net-based segmentation network) that is trained, using an image data set comprising a mix of synthetic and real data, to produce a segmentation mask of an object in a bounding box.

Object classifier 314(f) may be configured to identify an object in an input image crop obtained from object detector 314(d). In some aspects, object classifier 314(f) may perform image search using the input crop image to identify the most similar item(s) in a database of labeled images previously scraped from the internet. The object classifier 314(f) may further assign one or more categories attached to the identified most similar item(s) to the object depicted in the input image crop. Alternatively, or in addition to an image search, object classifier 314(f) may determine one or more categories for the object by using optical character recognition to extract text from the input image crop and searching a product database (e.g., product database 104(c) in FIG. 1) using the extracted text. Alternatively, or in addition to an image search and/or text search, object classifier 314(f) may determine one or more categories for the object by detecting a barcode (e.g., black-and-white stripes representing a UPC barcode or a square pattern representing a 2D or Quick-Response (QR) barcode), converting the detected barcode into a numeric or alphanumeric code, and searching a product database (e.g., product database 104(c) in FIG. 1). Furthermore, in some aspects, object classifier 314(f) may also be configured to verify that an object in an input image crop is an item on the assigned customer shopping list. For example, object classifier 314(f) may compare the results of at least one of an image search, text search, or barcode search as described above with items on the customer shopping list to determine whether the object matches one of the one or more items on the customer shopping list.

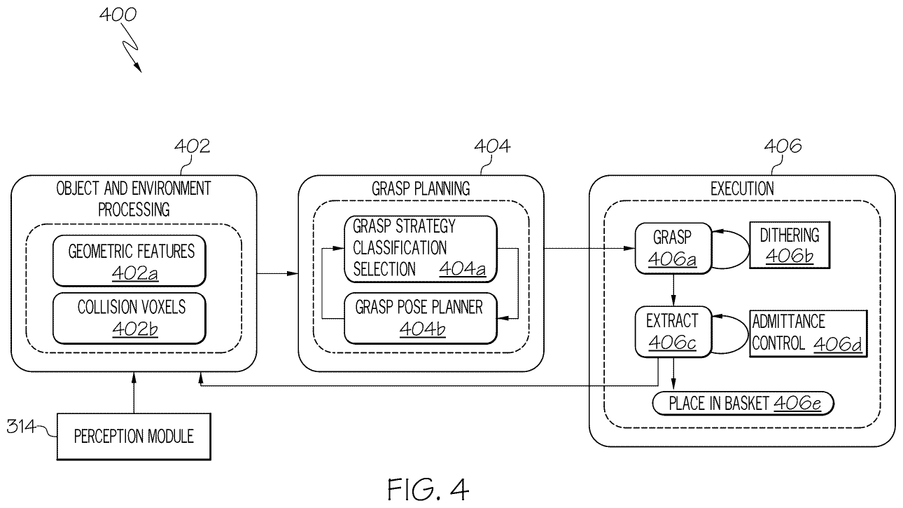

FIG. 4 illustrates an example pipeline 400 of grasp planner module 312 in FIG. 3. The example pipeline 400 may comprise three phases including, but not limited to, object and environment processing 402, grasp planning 404, and execution 406. In some aspects, object and environment processing 402 may comprise the grasp planner module 312 receiving segmented point cloud data for a target object and nearby object(s) from perception module 314 previously generated by object segmenter 314(e). Object and environmental processing 402 may comprise the grasp planner module 312 extracting relevant geometric feature(s) 402(a) from the segmented point cloud data. Relevant geometric features may include, but are not limited to, data describing the target object's shape, height, width, boundary or hull, as well as the size, flatness, or curvature of a front-facing side. In some aspects, any known or yet to be known technique for extracting relevant geometric features and potential collision voxels from 3D point clouds by one of ordinary skill in the art can be used in the embodiments disclosed in this document.

Object and environmental processing 402 may further comprise the grasp planner module 312 extracting potential collision voxels 402(b) from the segmented point cloud data. Potential collision voxels may include voxels that are considered non-traversable because they contain an obstacle or lies within a safety margin around one. During object and environment processing 402 of example pipeline 400, grasp planner module 312 may identify potential collision voxels between two objects (e.g., the left adjacent object and the target object and the target object and the right adjacent object) using any known or yet to be known technique by one of ordinary skill in the art. For example, object detector 314(d) may identify a right adjoining bounding box containing a right adjacent object and a left adjoining bounding box containing a left adjacent object. A right adjacent object may be an object that is immediately to the right of the target object, and a left adjacent object may be an object that is immediately to the left of the target object. The grasp planner module 312 may next receive the segmented point clouds of objects in bounding boxes adjoining the bounding box containing the target object from object segmenter 314(e). The grasp planner module 312 may further compute voxel-space axis-aligned bounding boxes (e.g., the smallest box of voxel indices covering an object) for both objects. Afterwards, the grasp planner module 312 may determine if the axis-aligned bounding boxes (AABBs) for the objects overlap. If the AABBs for the two objects do not overlap, the grasp planner module 312 may determine there is no possible between the voxels of each object. Otherwise, the grasp planner module 312 may examine overlapping region(s) of the AABBs for the two objects. The grasp planner module 312 may generate, for each object, a binary voxel grid representing the occupancy of 3D space in a discrete, voxelized form. Each voxel in a binary voxel grid stores whether the corresponding volume of space is occupied (1) or empty (0). For each voxel in the overlapping region(s) of the AABBs for the two objects, the grasp planner module 312 may determine the voxel is a potential collision voxel when the voxel is occupied in the binary voxel grids for both objects.

In some aspects, execution 406 may comprise grasp 406(a), dithering 406(b), extraction 406(c), admittance control 406(d), and placement in basket 406(e). Grasp 406(a) may comprise the grasp planner module 312 instructing, via the centralized behaviors module 304, the mobile manipulator robot 200 to execute the grasp pose and attach the selected grasping tool to the target object. Where suction gripper 212 is deployed to obtain the target object, the suction grasp may fail due to kinematic precision. Upon receiving an indication that the suction grasp failed upon initial contact (such as one or more measurements indicating insufficient vacuum levels from a pressure sensor coupled to the suction gripper 212), the grasp planner module 312 may instruct the mobile manipulator robot 200 to perform dithering 406(b), via the centralized behaviors module 304. Dithering 406(b) may comprise small, probing movements around an initial suction point. The small, probing movements may further involve moving suction gripper 212 back and forth while slightly varying its position in a direction perpendicular to the primary motion. This process may continue until the suction tool detects a pressure signal indicating a successful grasp or until a preset timeout occurs.

Extraction 406(c) may comprise the grasp planner module 312 instructing, via the centralized behaviors module 304, the mobile manipulator robot 200 to remove the grasping tool and attached target object from its environmental context (e.g., shelf, pile in a bin, hook, etc.). To ensure that the grasping tool does not exert excessive force on the environment, the grasp planner module 312 may employ an admittance controller 406(d). Admittance controller 406(d) models a dynamic relationship between force and motion and may be used to regulate how a component of the mobile manipulator robot 200 (e.g., the grasping tool) responds to an external force applied to it. An admittance controller 406(d) may be based on the following equation:

M_{d}\ddot{x}+B_{d}\dot{x}+K_{d}x=F^{ext} (Eq. 1)

Where M_{d} is the desired inertia (e.g., how hard it is to accelerate), \ddot{x} is acceleration, B_{d} is the desired damping (e.g., resistance to velocity), \dot{x} is velocity, K_{d} is a stiffness matrix defining the desired stiffness, x is position, and F^{ext} is the measured external force. Using admittance control, the grasp planner module 312 may compute the trajectory, x(t), of the grasping tool. Additionally, the stiffness matrix, K_{d}, may include non-diagonal coupling terms rather than diagonal coupling terms. By utilizing a stiffness matrix with non-diagonal coupling terms, the grasp planner module 312 may guide the grasping tool in a specific direction rather than modifying the trajectory of the grasping tool only in the direction where the external force occurs, as is the case when diagonal terms are used in the stiffness matrix. For example, a stiffness matrix with non-diagonal coupling terms may be used to translate a deviation in one direction caused by an application of applied in that direction into motion in another direction. The non-diagonal coupling terms of a stiffness matrix can further be derived before application of an external force since the stiffness matrix does not interfere with the trajectory of an object, such as a grasping tool of mobile manipulation robot 200. Furthermore, in some aspects, an external force applied to a grasping tool of the mobile manipulator robot 200 may be due to a collision of the target object with a display fixture (e.g., a lip of a shelf) during extraction by the grasping tool. In such cases, the collision may be detected by a six-axis force/torque sensor mounted between a wrist linkage and a tool interface of the 7-DoF arm 208 attached to the grasping tool, and external force data indicating the detected collision may be communicated to the grasp planner module 312. Upon receiving data indicating a collision, the grasp planner module 312 may instruct, via the centralized behaviors module 304, to move the 7-DoF arm 208 in an upward direction, wherein an acceleration of the 7-DoF arm 208 in the upward direction is generated based on the external force data and the non-diagonal coupling terms in the stiffness matrix of the admittance controller 406(d).

Finally, in some aspects, placement in basket 406(e) may comprise the grasp planner module 312 instructing, via the centralized behaviors module 304, the mobile manipulator robot 200 to place the target object in a basket attached to the chassis 202.

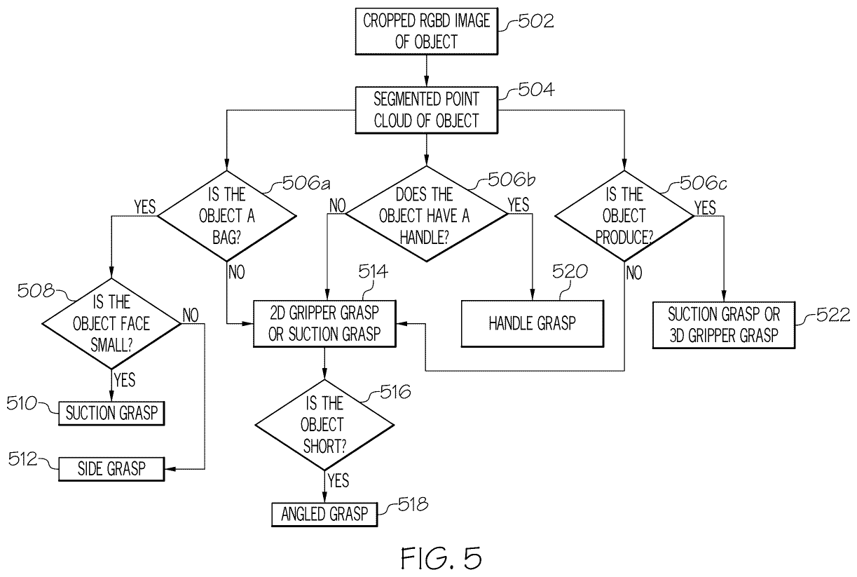

FIG. 5 illustrates an example method 500 for grasp strategy classification and tool selection. Method 500 can be performed by processing logic that can comprise hardware (e.g., circuitry, dedicated logic, programming logic, microcode, etc.), software (e.g., instructions executing on a processing device), or a combination thereof. Furthermore, some of the steps may be performed simultaneously, or in a different order than one shown in FIG. 5, as will be understood by a person of ordinary skill in the art. Method 500 shall be described with reference to FIGS. 2-4. However, method 500 is not limited to that embodiment.

Method 500 may begin with block 502, which includes receiving a cropped image (or image crop) of a target object. In some aspects, an image crop of a target object may be generated by object detector 314(d) of perception module 314. Upon receiving an RGB-D image from stereo component 314(a), the object detector 314(d) may detect one or more objects in the image, generate a 2D bounding box around each of the one or more detected objects, and output an image crop (or cropped image) of an object in each of the one or more 2D bounding boxes.

Block 504 includes receiving a segmented point cloud of the target object. In some aspects, object segmenter 314(e) of perception module 314 may generate based on an image crop of the target object from provided by object detector 314(d). For example, object segmenter 314(e) may employ a U-Net-based segmentation network to create a segmentation mask from the image crop of the target object. Afterwards, object segmenter 314(e) may overlay the segmentation mask with the RGB-D image from stereo component 314(a) to filter out pixels not belonging to the target object in the input image crop from which the segmentation mask is derived. Object segmenter 314(e) may generate the segmented point cloud of the target object by back-projecting each pixel of the remaining pixels of the RGB-D image into a 3D point cloud. Object segmenter 314(e) may further output the segmented point cloud of the target object to grasp planner module 312. Finally, the grasp planner module 312 may extract relevant geometric feature(s) of the target object and/or potential collision voxels from the segmented point cloud.

Block 506 includes the grasp planner module 312 determining (either sequentially or simultaneously) whether the target object is a bagged item at 506(a), whether the target object is handle-item at 506(b), or whether the target object is a produce item at 506(c). In some aspects, grasp planner module 312 may utilize one or more neural networks to classify the target object as a bagged item, a handle-item, a produce item, or none of the above based on the segmented point cloud of the target object. If the target object is identified as a bagged item at block 506(a), method 500 may proceed to block 508. Block 508 includes the grasp planner module 312 determining whether the target object face is small based on the relevant geometric feature(s) extracted from the segmented point cloud. If the target object face is small, method 500 may proceed to block 510. Block 510 includes the grasp planner module 312 applying a suction grasp to the target object using suction gripper 212. Otherwise, if the target object face is not small, method 500 may proceed to block 512. Block 512 includes the grasp planner module 312 applying a side grasp to the target object using antipodal gripper 210.

Alternatively, if the target object is identified as a handle-item at block 506(b), method 500 may proceed block 520. Block 520 includes the grasp planner module 312 applying a handle-item grasp to the target object using antipodal gripper 210. Otherwise, if the target object is identified as a produce item at block 506(c), method 500 may proceed to block 522. Block 522 includes the grasp planner module 312 applying either a suction grasp to the target object using suction gripper 212 or a 3D gripper grasp to the target object using antipodal gripper 210.

However, if grasp planner module 312 determines that the target object is not one of a bagged item, handle-item, or produce item at blocks 506(a), 506(b), and 506(c), method 500 may proceed to block 514. Block 514 includes the grasp planner module 312 applying either a suction grasp or a 2D suction grasp to the target object using suction gripper 212. Furthermore, in some aspects, method 500 may additionally include block 516, which entails the grasp planner module 312 determining whether object is short based on the relevant geometric feature(s) extracted from the segmented point cloud. If the target object is short, method 500 may proceed to block 518. Block 518 includes the grasp planner module 312 applying an applying angle grasp to the target object. In some aspects, an angle grasp may entail applying antipodal gripper 210 or suction gripper 212 to the target object at a predetermined angle.

### Example Method for Grasp Strategy for Manipulation Using a Side Grasp

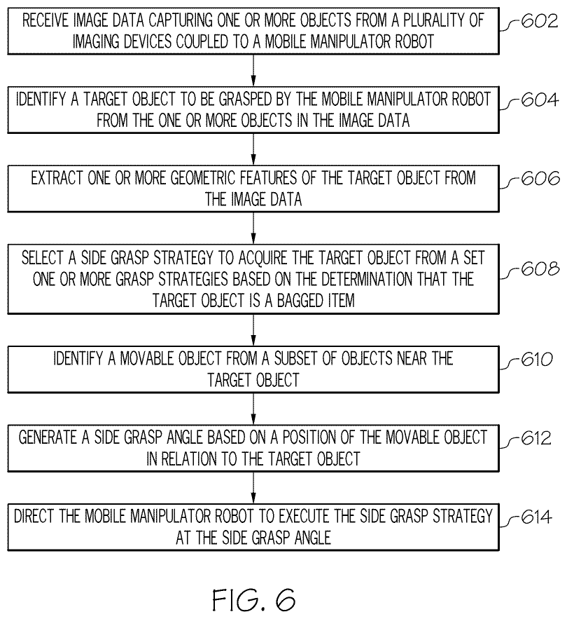

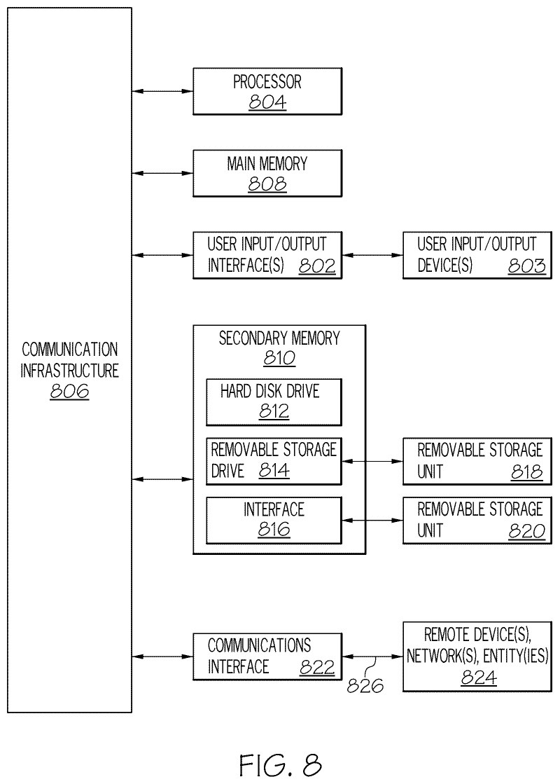

FIG. 6 depicts an example method 600 to select and execute a side grasp strategy for manipulation of a bagged item. Method 600 can be performed by processing logic that can comprise hardware (e.g., circuitry, dedicated logic, programming logic, microcode, etc.), software (e.g., instructions executing on a processing device), or a combination thereof. For example, in one aspect, method 600 can be implemented by the system 800 of FIG. 8. Furthermore, some of the steps may be performed simultaneously, or in a different order than one shown in FIG. 6, as will be understood by a person of ordinary skill in the art. Method 600 shall be described with reference to FIGS. 2-5. However, method 600 is not limited to that embodiment.

Method 600 may begin with block 602, which includes receiving image data capturing one or more objects from a plurality of imaging devices coupled to a mobile manipulator robot 200. In some aspects, the plurality of imaging devices may comprise one or more stereo camera pairs 214, such as a pair of color cameras with wide-angle lenses mounted on the 2-DoF pan-tilt platform 206 and another front-facing pair mounted to the four-wheeled chassis 202 of the mobile manipulator robot 200 in FIG. 2. The image data may further comprise at least one RGB-D image generated based on stereo image pairs captured by the one or more stereo camera pairs 214. Additionally, in some aspects, the image data may be obtained upon the mobile manipulator robot 200 arriving to a location in the environment that is at or near the one or more objects. The location at or near the one or more objects may be an expected or predetermined location of an item (e.g., a first item on an ordered sequence of items) on a customer shopping list. As previously discussed, the mobile manipulator robot 200 may navigate to the expected or predetermined location(s) of one or more items in an environment based on a motion plan (e.g., collision-free route) that is generated by motion planner module 310 when the mobile manipulator robot 200 receives a customer shopping list from host 104.

Block 604 includes identifying a target object to be grasped by the mobile manipulator robot 200 from the one or more objects in the image data. In some aspects, object detector 314(d) of the perception module 314 may detect one or more objects in the at least one RGB-D image and generate a 2D bounding box around each of the one or more detected objects. Object detector 314(d) may select a 2D bounding box from the one or more 2D bounding boxes, generate an image crop for the object within the selected 2D bounding box, and output the image crop to the object segmenter 314(e) and object classifier 314(f). In some aspects, object detector 314(d) may also estimate a position (e.g., height) and orientation for each object detected in the at least one RGB-D image.

Object classifier 314(f) may attempt to identify the object depicted in an image crop by performing an image search using the input crop image to determine the most similar item(s) in a database of labeled images previously scraped from the internet. Alternatively, or in addition to an image search, object classifier 314(f) may identify the object in an image crop by extracting text from the image using optical character recognition and searching a product database (e.g., product database 104(c)) using the extracted text. Alternatively, or in addition to an image search and/or text search, object classifier 314(f) may identify the object in an image crop by detecting a barcode (e.g., black-and-white stripes representing a UPC barcode or a square pattern representing a 2D or Quick-Response (QR) barcode), converting the detected barcode into a numeric or alphanumeric code, and searching a product database (e.g., product database 104(c)). If an object depicted in an image crop cannot be identified based on an image search, text search, and/or barcode search, the object classifier 314(f) may request a second image crop from object detector 314(d). Object detector 314(d) may, in turn, transmit a second image crop associated with a second 2D bounding selected from the one or more bounding boxes to object segmenter 314(e) and object classifier 314(f). Upon receiving the second image crop, object classifier 314(f) may again attempt to identify the object depicted in the second image crop.

If the object classifier 314(f) successfully identifies an object in the image crop, the object classifier 314(f) may compare the object (as identified by the results of at least one of image search, text search, or barcode search) to a specific item on the customer shopping list that is associated with the current location of the mobile manipulator robot 200. Alternatively, or in addition to determining whether the identified object matches an item on the customer shopping list that corresponds to the current location of the mobile manipulator robot 200, the object classifier 314(f) may determine whether the identified object matches any of the one or more items on the customer shopping list. If the object classifier 314(f) determines that an identified object matches a specific item associated with the current location of the mobile manipulator robot 200 (or any item on the customer shopping list), the object classifier 314(f) may designate the identified object as a target object to be grasped by the mobile manipulator robot 200. Perception module 314 may then transmit data indicating a match to the grasp planner module 312. Such data may include, but is not limited to, an estimated position and orientation of the target object from object detector 314(d) and a segmented point cloud of the target object from object segmenter 314(e). As previously explained, a segmented point cloud of the target object may comprise a 3D point cloud representing the target object. Object segmenter 314(e) may generate a segmented point cloud of the target object by creating a segmentation mask from the image crop depicting the target object, overlaying the segmentation mask with the RGB-D image from stereo component 314(a) to filter out pixels not belonging to the target object, and back-projecting each pixel of the remaining pixels of the RGB-D image on to a 2D plane of the target object. However, if the identified object does not match a specific item associated with the current location of the mobile manipulator robot 200 (or any item on the customer shopping list), the object classifier 314(f) may request a second image crop from object detector 314(d). Object detector 314(d) may respond to the request by transmitting a second image crop associated with a second 2D bounding selected from the one or more bounding boxes to object segmenter 314(e) and object classifier 314(f). Upon receiving the second image crop, object classifier 314(f) may again attempt to identify the object depicted in the second image crop.

Furthermore, if the object classifier 314(f) cannot identify any of the objects detected in the at least one RGB-D image or if the object classifier 314(f) cannot match any of the detected objects with a specific item on the customer shopping list that is associated with the current location of the mobile manipulator robot 200 (or any item on the customer shopping list), the perception module 314 may transmit data indicating “No Match” to grasp planner module 312. Grasp planner module 312 may also relay data indicating “No Match” to task planner module 302 via the centralized behaviors module 304. Task planner module 302 may further instruct, via the centralized behaviors module 304, the mobile manipulator robot 200 to navigate to a location associated with the next item on the customer shopping list.

Block 606 includes extracting one or more geometric features of the target object from the image data. For example, during object and environment processing 402 of example pipeline 400 in FIG. 4, grasp planner module 312 may extract the one or more geometric features from the segmented point cloud of the target object.

Block 608 includes selecting a side grasp strategy to acquire the target object from a set of grasp strategies based on the one or more geometric features of the target object. During grasp strategy classification and tool selection 404a of example pipeline 400, grasp planner module 312 may utilize at least one neural network to analyze the one or more geometric features of the target object and determine whether the target object is a bagged item, a handle-item, a produce item, or none of the above during grasp strategy classification and tool selection 404a of example pipeline 400. Based on the output of the at least one neural network, the grasp planner module 312 may select a grasp strategy, and by extension, the appropriate tool using a learned mapping depicted in FIG. 5. For example, as depicted in element 512 of FIG. 5, the grasp planner module 312 may determine that the appropriate grasp strategy may be a side grasp strategy when the at least one neural network determines that the target object is a bagged item with a large object face. Furthermore, in some aspects, the appropriate tool for a side grasp strategy may be an antipodal gripper comprising a plurality of fingers, such as the antipodal gripper 210 in FIG. 2.

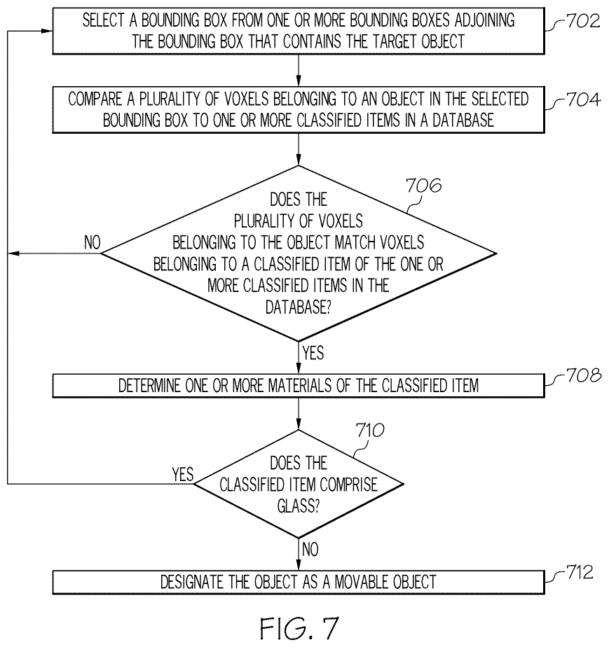

Block 610 includes identifying a movable object from a subset of objects near the target object. For example, during grasp pose planner 404b of example pipeline 400, the grasp planner module 312 may identify a movable object from a subset of objects near the target object. An example method to identify a movable object from a subset of objects near the target object is described in further detail in FIG. 7.

Block 612 includes generating a side grasp angle based on a position of the movable object in relation to the target object. Following identification of a movable object near the target object, the grasp planner module 312 may determine its position relative to the target object (e.g., left or right of the target object). Afterwards, the grasp planner module 312 may perform iterative collision checks to identify a highest side grasp angle of the antipodal gripper 210 that minimizes collisions between voxels belonging to the antipodal gripper 210 and voxels belonging to the movable object. For example, during grasp pose planner 404b of example pipeline 400, the grasp planner module 312 may iteratively simulate potential voxel collisions as the open plurality of fingers of antipodal gripper 210 are rotated towards the target object to grasp a portion of the target object. In some aspects, the grasp planner module 312 may rotate the antipodal gripper 210 in a upwards direction (or alternatively, in a downwards direction) in predefined increments (e.g., five degrees, ten degrees, fifteen degrees, etc.) until the grasp planner module 312 determines a potential collision between voxels belonging to the antipodal gripper 210 and voxels belonging to a shelving infrastructure above the target object.

Block 614 includes directing the mobile manipulator robot 200 to execute the side grasp strategy at the highest side grasp angle. For example, during the grasp 406a stage in execution 406 of example pipeline 400, the grasp planner module 312 may direct the mobile manipulator robot 200 to advance the antipodal gripper 210 with its plurality of fingers closed towards the target object such that the antipodal gripper 210 is proximate and perpendicular to an edge on a face of the target object (e.g., frontside of the target object visible to the imaging device) farthest from the movable object. Alternatively, in other aspects, the grasp planner module 312 may direct the mobile manipulator robot 200 to advance the antipodal gripper 210 with its plurality of fingers closed towards the target object such that the antipodal gripper 210 is proximate and perpendicular to a center position on a face of the target object (e.g., frontside of the target object visible to the imaging device). The grasp planner module 312 may direct the mobile manipulator robot 200 to sweep the antipodal gripper 210 across the face of the target object towards the movable object until the plurality of fingers of the antipodal gripper 210 are located between the target object and the movable object. Once the antipodal gripper 210 is between the target object the movable object, the grasp planner module 312 may direct the mobile manipulator robot 200 to open its plurality of fingers. The grasp planner module 312 may direct the mobile manipulator robot 200 to align the antipodal gripper 210 horizontally with the target object such that an edge or portion of the target object closest to the moveable object fits within the opened plurality of fingers of antipodal gripper 210. In doing so, the mobile manipulator robot 200 may use intermediate waypoints to push aside any neighboring items that block access to the target. The grasp planner module 312 may direct the mobile manipulator robot 200 to rotate the antipodal gripper 210 to the highest side grasp angle previously determined at block 612 and grasp the target object by closing the plurality of fingers of antipodal gripper 210.

Afterwards, the mobile manipulator robot 200 may extract the target object from its environment. For example, during the extract 406(c) stage in execution 406 of example pipeline 400, the grasp planner module 312 may direct the mobile manipulator robot 200 to move the antipodal gripper 210 and attached target object back towards the mobile manipulator robot 200. The mobile manipulator robot 200 may continue this movement until the antipodal gripper 210 reaches a pre-grasp position or until a collision between the target object and a display fixture (e.g., a lip of a shelf) is detected. In the event of a collision between the target object and the display fixture, the grasp planner module 312 may receive signal with external force data indicating the collision from a force sensor coupled to the robotic arm attached to the antipodal gripper 210. In some aspects, the force sensor may comprise a six-axis force/torque sensor mounted between a wrist linkage and a tool interface of the 7-DoF arm 208 previously described in FIG. 2. If the grasp planner module 312 receives data indicating a collision, the grasp planner module 312 may direct the mobile manipulator robot 200 to navigate the target object around the display fixture during an admittance control stage 406(d) in the execution phase 406 of example pipeline 400. In some aspects, the mobile manipulator robot 200 may navigate the target object around the display fixture by moving the robotic arm in an upward direction for a predetermined distance. Acceleration of the robotic arm in the robotic arm in the upward direction may be generated based on the external force data and the non-diagonal coupling term in the stiffness matric of the admittance controller. Afterwards, the grasp planner module 312 may revert to the extract 406(c) stage and direct the mobile manipulator robot 200 to move the antipodal gripper 210 and the target object back towards the mobile manipulator robot 200. However, if the grasp planner module 312 receives a second signal with second external force data indicating a second (or continued) collision between the target object and the display fixture, the grasp planner module 312 may return to the admittance control 406(d) stage and again direct the mobile manipulator robot 200 to move the robotic arm in an upward direction for a predetermined distance. The grasp planner module 312 may alternate between the extract 406(c) stage and the admittance control 406(d) stage of execution 406 until the mobile manipulator robot 200 successfully navigates the target object away from the display fixture.

Finally, once the antipodal gripper 210 and the target object has returned to a pre-grasp position, method 600 may also include the grasp planner module 312 placing the target object in a basket attached to the chassis 202 of mobile manipulator robot 200. For example, during a place in basket 406(e) stage of execution 406 in the example pipeline 400, the grasp planner module 312 may direct the mobile manipulator robot 200 to move the antipodal gripper 210 to a position centered above the basket and lower the target object into the basket until the grasp planner module 312 receives external force data indicating a collision between the target object and another object in the basket or the bottom of the basket. Once the mobile manipulator robot 200 has placed the target object in the basket, grasp planner module 312 may transmit a signal indicating successful completion of example pipeline 400 and acquisition of the target object to task planning module 302, via the centralized behaviors module 304.

Note that FIG. 6 is just one example of a method, and other methods including fewer, additional, or alternative operations are possible consistent with this disclosure.

FIG. 7 illustrates an example method to identify a movable object from a subset of objects near a target object. Method 700 can be performed by processing logic that can comprise hardware (e.g., circuitry, dedicated logic, programming logic, microcode, etc.), software (e.g., instructions executing on a processing device), or a combination thereof. For example, in one aspect, method 700 can be implemented by the system 800 of FIG. 8. Furthermore, some of the steps may be performed simultaneously, or in a different order than one shown in FIG. 7, as will be understood by a person of ordinary skill in the art. Method 700 shall be described with reference to FIGS. 2-5. However, method 700 is not limited to that embodiment.

Method 700 may begin block 702, which includes selecting a bounding box from one or more bounding boxes adjoining (or adjacent to) the bounding box that contains the target object. In some aspects, the one or more bounding boxes adjoining the bounding box that contains the target object may comprise a first adjoining bounding box immediately to the left of the bounding box containing the target object and a second adjoining box immediately to the right of the bounding box containing the target object. Furthermore, in some aspects, the first adjoining bounding box may contain a left adjacent object that is immediately to the left of the target object, and the second adjoining bounding box may contain a right adjacent object that is immediately to the right of the target object.

Block 704 includes comparing a plurality of voxels belonging to an object in the selected bounding box to one or more classified items in a database. For example, during object and environment processing 402 of example pipeline 400, the grasp planner module 312 may receive the segmented point cloud of a left adjacent object in the first adjoining bounding box and/or the segmented point cloud of a right adjacent object in the second adjoining bounding box from object segmenter 314(e). The grasp planner module 312 may further generate a plurality of voxels representing the right adjacent object and/or a plurality of voxels representing the left adjacent object based on their respective segmented point clouds using any known or yet to be known technique by one of ordinary skill in the art. The grasp planner module 312 may next compare the plurality of voxels representing the right adjacent object and/or the plurality of voxels representing the left adjacent object to voxels representing each of the one or more classified items in a database. In some aspects, the database of one or more classified items may be a second database separate from the product database 104 in FIG. 1 and comprises labeled voxel data sets for each of the one or more classified items. In other aspects, the labeled voxel data sets for each of the one or more classified items may be included in the product database 104 in FIG. 1.

Diamond 706 includes determining whether the plurality of voxels representing the object (e.g., a right adjacent object or a left adjacent object) in the selected bounding box match voxels belonging to a classified item of the one or more classified items in a database. If the plurality of voxels representing the object fail to match voxels belonging to any of the classified items in the database, the grasp planner module 312 may designate the object as an immovable object, or an object that the mobile manipulator robot 200 should not interact with, because the object is part of the shelving infrastructure and most likely rigid. In such cases, method 700 may return to block 702, which entails the grasp planner module 312 selecting a second bounding box from the one or more bounding boxes adjoining the bounding box that contains the target object. For example, if the grasp planner module 312 originally selected an adjoining bounding box immediately to the right of the bounding box containing the target object at block 702, the grasp planner module 312 may select the adjoining bounding box immediately to the left of the bounding box containing the target object upon determining that the plurality of voxels representing the right adjacent object fail to match voxels belonging to a classified item in the database. Furthermore, the grasp planner module 312 may abort planning of the side grasp strategy upon determining that neither the plurality of voxels representing the right adjacent object nor the plurality of voxels representing the left adjacent object match voxels belonging to a classified item in the database. However, if the plurality of voxels representing the object match voxels belonging to a classified item in the database, method 700 may proceed to block 708.

Block 708 includes determining one or more materials of the classified item matching the plurality of voxels representing the object in the selected bounding box. During object and environment processing 402 of example pipeline 400, the grasp planner module 312 may obtain data specifying one or more materials used in the packaging or manufacture of the matching classified item, including, but not limited to, plastic, cardboard, metal, or glass. In some aspects, the grasp planner module 312 may obtain the data specifying one or more materials used in the packaging or manufacture of the matching classified item from the product database 104 or a separate database of one or more classified items. Alternatively, in other aspects, the grasp planner module 312 may search for the matching classified item in a database of known glass items.

Diamond 710 includes determining whether the matching classified item comprises glass based on the results of a search for the classified item in one of the product database 104, the database of one or more classified items, or the database of known glass items. If the matching classified item comprises glass, the grasp planning module 312 may designate the object in the selected bounding box as an immovable object to reduce the likelihood of the object being accidentally knocked off the shelf by the mobile manipulator robot 200 and breaking. In such cases, method 700 may return to block 702, which entails the grasp planner module 312 selecting a second bounding box from the one or more bounding boxes adjoining the bounding box that contains the target object. Furthermore, the grasp planner module 312 may abort planning of the side grasp strategy upon determining that the objects on either side of the target object (e.g., the right adjacent object and the left adjacent object) are both designated as immovable objects because they contain glass or a part of the shelving infrastructure. However, if the matching classified item does not comprise glass, method 700 may proceed to block 712, which includes the grasp planner module 312 designating the object in the selected bounding box as a movable object that the mobile manipulator robot 200 can interact with or push aside using antipodal gripper 210 in order to gain access to the target object.

### Example Processing System for Grasp Strategy for Manipulation Using a Side Grasp

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may be an example of an electronic device configured to execute computer-executable instructions, such as those derived from compiled computer code, including without limitation personal computers, tablet computers, servers, smart phones, smart devices, wearable devices, augmented and/or virtual reality devices, and others.

Computer system 800 may also be a client or server, accessing or hosting any applications and/or data through any delivery paradigm, including but not limited to remote or distributed cloud computing solutions; local or on-premises software (“on-premise” cloud based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Computer system 800 may include one or more processors (also called central processing units, or CPUs), such as a processor 804. Processor 804 may be representative of one or more central processing units (CPUs), graphics processing unit (GPUs), tensor processing unit (TPUs), accelerators, and other processing devices. Processor 804 may be connected to a communication infrastructure or bus 806. In certain embodiments, processor 804 may be a GPU, which is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may include user input/output device(s) 803, which may comprise any device, mechanism, system, interactive display, and/or various other hardware and software components for communicating information between computer system 800 and a user of the computer system 800 through user input/output interface(s) 802. For example, input/output device(s) 804 may include input hardware, such as a keyboard, touch screen, button, microphone, speaker, and/or other device for receiving inputs from the user and sending outputs to the user.

Computer system 800 may include a main or primary memory 808, such as random-access memory (RAM). Main memory 808 may include one or more levels of cache. Main memory 808 may have stored therein control logic (i.e., computer software) and/or data.

Computer system 800 may include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities, or other approaches for allowing computer programs and/or other instructions and/or data to be accessed by computer system 800. Such means, devices, components, instrumentalities, or other approaches may include, for example, a removable storage unit 820 and an interface 816. Examples of the removable storage unit 820 and the interface 816 may include a program cartridge and cartridge interface (such as that found in video game devices), a removable memory chip (such as an EPROM or PROM) and associated socket, a memory stick and USB port, a memory card and associated memory card slot, and/or other removable storage unit and associated interface.

Computer system 800 may further include a communications or network interface 824. Communications interface 822 may enable computer system 800 to communicate and interact with any combination of external devices, external networks, external entities, etc. (individually and collectively referenced by reference number 824). Communications interface 822 can generally be any hardware and/or software capable of transmitting and/or receiving data via over communications path 826, which may be wired and/or wireless (or a combination thereof), and which may include any combination of LANs, WANs, the Internet, etc. For example, communications interface 822 can include a communication transceiver for sending and/or receiving any wired and/or wireless communication. Furthermore, control logic and/or data may be transmitted to and from computer system 800 via communications path 826.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 820, as well as tangible articles of manufacture embodying any combination of the foregoing. Such control logic, when executed by one or more data processing devices (such as computer system 800), may cause such data processing devices to operate as described herein.

Note that FIG. 8 is just one example of a processing system consistent with aspects described herein, and other processing systems having additional, alternative, or fewer components are possible consistent with this disclosure. Based on the teachings contained in this disclosure, it will be apparent to persons skilled in the relevant art(s) how to make and use embodiments of this disclosure using data processing devices, computer systems, and/or computer architectures other than that shown in FIG. 8. In particular, embodiments can operate with software, hardware, and/or operating system implementations other than those described herein.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to:
receive image data capturing one or more objects from a plurality of imaging devices coupled to a mobile manipulator robot;
identify a target object to be grasped by the mobile manipulator robot from the one or more objects in the image data, wherein the target object comprises a bagged item;
extract one or more geometric features of the target object from the image data;
select a side grasp strategy to acquire the target object from a set of one or more grasp strategies based on the one or more geometric features of the target object; and
direct the mobile manipulator robot to execute the side grasp strategy.

2. The apparatus of claim 1, wherein to identify the target object from the one or more objects, the processing system is further configured to:
segment the image data into one or more bounding boxes, wherein each bounding box of the one or more bounding boxes contains an object of the one or more objects;
select a bounding box from the one or more bounding boxes;
classify the object in the bounding box by performing at least one of an image search, barcode search, or text search;
determine whether the object is on a customer shopping list based on a comparison of items on the customer shopping list with results of the at least one of the image search, barcode search, or text search; and
identify the object as the target object to be grasped by the mobile manipulator robot when the object matches one of the items on the customer shopping list.

3. The apparatus of claim 2, the processing system is further configured to:
identify a movable object from a subset of objects near the target object;
determine a position of the movable object relative to the item; and
generate a side grasp angle based on the position of the movable object.

4. The apparatus of claim 3, wherein to identify the movable object from the subset of objects near the target object, the processing system is further configured to:
select a bounding box from the one or more bounding boxes adjoining the bounding box containing the target object; and
compare a plurality of voxels belonging to an object in the selected bounding box with voxels belonging to one or more classified items in a database.

5. The apparatus of claim 4, the processing system is further configured to:
identify the object in the selected bounding box as shelving infrastructure based on the plurality of voxels belonging to object in the selected bounding box not matching the voxels belonging to any classified item of the one or more classified items in the database; and
designate, based on the identification, the object in the selected bounding box as an immovable object that the mobile manipulator cannot touch or interact with.

6. The apparatus of claim 4, the processing system is further configured to determine one or more materials of a matching classified item based on the plurality of voxels belonging to the object in the selected bounding box matching the voxels belonging to one of the one or more classified items in the database.

7. The apparatus of claim 6, the processing system is further configured to designate the object in the selected bounding box as an immovable object that the mobile manipulator cannot touch or interact with based on a determination that the one or more materials comprise glass.

8. The apparatus of claim 6, the processing system is further configured to designate the object in the selected bounding box as the movable object based on a determination that the one or more materials do not comprise glass.

9. The apparatus of claim 8, wherein to generate the side grasp angle based on the position of the movable object, the processing system is further configured to perform iterative collision checks to identify a highest side grasp angle that minimizes collisions with voxels belonging to the movable object.

10. The apparatus of claim 9, wherein to direct the mobile manipulator robot to execute the side grasp strategy, the processing system is further configured to:
direct the mobile manipulator robot to advance an antipodal gripper coupled to a robotic arm of the mobile manipulator robot proximate and perpendicular to an edge of the target object opposite of the movable object;
direct the mobile manipulator robot to sweep the antipodal gripper across the target object towards the position of the movable object until the antipodal gripper is located between the target object and the movable object;
direct the mobile manipulator robot to open a plurality of fingers of the antipodal gripper;
direct the mobile manipulator robot to rotate the antipodal gripper to the highest side grasp angle; and
direct the mobile manipulator robot to close the plurality of fingers of the antipodal gripper on an edge of the target object closest to the movable object.

11. An mobile manipulator robot, comprising:
a chassis coupled to a body;
one or more robotic arms coupled to and extended from the body, wherein at least one robotic arm of the one or more robotic arms is coupled to an antipodal gripper;
an imaging device coupled to the body and configured to capture one or more objects in an environment;
one or more transportation components coupled to the chassis, the one or more transportation components configured to move in a plurality of directions;
a processing device in communication with the one or more robotic arms, the imaging device, and the one or more transportation components;
a non-transitory, computer-readable storage medium in communication with the processing device, wherein the non-transitory, computer-readable storage medium comprises programming instructions that, when executed, cause the processing device to perform operations, the operations comprising:
receiving image data capturing one or more objects from a plurality of imaging devices coupled to a mobile manipulator robot;
identifying a target object to be grasped by the mobile manipulator robot from the one or more objects in the image data, wherein the target object comprises a bagged item;
extracting one or more geometric features of the target object from the image data;
selecting a side grasp strategy to acquire the target object from a set of one or more grasp strategies based on the one or more geometric features of the target object; and
directing the mobile manipulator robot to execute the side grasp strategy.

12. The mobile manipulator robot of claim 11, wherein identifying the target object from the one or more objects comprises:
segmenting the image data into one or more bounding boxes, wherein each bounding box of the one or more bounding boxes contains an object of the one or more objects;
selecting a bounding box from the one or more bounding boxes;
classifying the object in the bounding box by performing at least one of an image search, barcode search, or text search;
determining whether the object is on a customer shopping list based on a comparison of items on the customer shopping list with results of the at least one of the image search, barcode search, or text search; and
identifying the object as the target object to be grasped by the mobile manipulator robot when the object matches one of the items on the customer shopping list.

13. The mobile manipulator robot of claim 12, the operations further comprising:
identifying a movable object from a subset of objects near the target object;
determining a position of the movable object relative to the item; and
generating a side grasp angle based on the position of the movable object.

14. The mobile manipulator robot of claim 13, wherein identifying the movable object from the subset of objects near the target object comprises:
selecting a bounding box from the one or more bounding boxes adjoining the bounding box containing the target object; and
comparing a plurality of voxels belonging to an object in the selected bounding box with voxels belonging to one or more classified items in a database.

15. The mobile manipulator robot of claim 14, the operations further comprising:
identifying the object in the selected bounding box as shelving infrastructure based on the plurality of voxels belonging to object in the selected bounding box not matching the voxels belonging to any classified item of the one or more classified items in the database; and
designating, based on the identification, the object in the selected bounding box as an immovable object that the mobile manipulator robot cannot touch or interact with.

16. The mobile manipulator robot of claim 14, the operations further comprising determining one or more materials of a matching classified item based on the plurality of voxels belonging to the object in the selected bounding box matching the voxels belonging to one of the one or more classified items in the database.

17. The mobile manipulator robot of claim 16, the operations further comprising designating the object in the selected bounding box as an immovable object that the mobile manipulator robot cannot touch or interact with based on a determination that the one or more materials comprise glass.

18. The mobile manipulator robot of claim 16, the operations further comprising designating the object in the selected bounding box as the movable object based on a determination that the one or more materials do not comprise glass.

19. The mobile manipulator robot of claim 18, wherein directing the mobile manipulator robot to execute the side grasp strategy comprises:
directing the mobile manipulator robot to advance an antipodal gripper coupled to a robotic arm of the mobile manipulator robot proximate and perpendicular to an edge of the target object opposite of the movable object;
directing the mobile manipulator robot to sweep the antipodal gripper across the target object towards the position of the movable object until the antipodal gripper is located between the target object and the movable object;
directing the mobile manipulator robot to open a plurality of fingers of the antipodal gripper;
directing the mobile manipulator robot to rotate the antipodal gripper to a highest side grasp angle, wherein highest side grasp angle minimizes collisions with voxels belonging to the movable object; and
directing the mobile manipulator robot to close the plurality of fingers of the antipodal gripper on an edge of the target object closest to the movable object.

20. A method, comprising:
receiving image data capturing one or more objects from a plurality of imaging devices coupled to a mobile manipulator robot;
identifying a target object to be grasped by the mobile manipulator robot from the one or more objects in the image data, wherein the target object comprises a bagged item;
extracting one or more geometric features of the target object from the image data;
selecting a side grasp strategy to acquire the target object from a set of one or more grasp strategies based on the one or more geometric features of the target object; and
directing the mobile manipulator robot to execute the side grasp strategy.
